(19) United States
(12) Patent Application Publication
(10) Pub. No.: US 2003/0068069 A1
(43) Pub. Date: Apr. 10, 2003

(54) Image processing apparatus having electronic watermark information detection function

(75) Inventor: Hideyasu Suzuki, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/260,492

(22) Filed: Oct. 1, 2002

(30) Foreign Application Priority Data
Oct. 5, 2001 (JP) 2001-310200

(51) Int. Cl. G06K 9/00

(52) U.S. Cl. 382/100

(57) ABSTRACT

In a case where electronic watermark information has been added to an input image input by scanning or the like of a recording medium such as a paper medium, a predetermined process such as an image deterioration process based on a kind of electronic watermark information previously determined on a table is performed to the input image, and the processed image is then output externally, thereby preventing to duplicate the image having a copyright.

### BACKGROUND OF THE INVENTION

1. Field of the Invention

The present invention relates to an image processing apparatus which is used in, e.g., an apparatus or a system for reading by a scanner or the like an image printed on paper, detecting invisible electronic watermark information from the read image, and then performing a process in accordance with the detected electronic watermark information.

2. Related Background Art

In recent years, computers have become remarkably widespread, and also peripheral devices such as a scanner, a printer and the like have become remarkably developed. Therefore, for example, an image once output and printed on paper (hereinafter, called a former image) is read and digitized by a scanner, and the digitized image is output and printed by the printer, whereby a large number of duplicates (or reproductions) of the former image can be formed. For this reason, in order to protect a copyright of the former image, it is thought to perform an image process in which copyright information and user information of the former image are embedded in the former image as electronic watermark information detectable from the former image.

However, in such a conventional image processing method of protecting the copyright, for example, a printed paper on which the former image has been output and printed is first scanned by the scanner, the read image obtained by the scan is captured into a host computer, and then a detection process to detect the electronic watermark information from the read image is performed in the host computer. Therefore, the read image, i.e., the former image, remains in the memory of the host computer, whereby there is a fear that the former image remaining in the memory is improperly and illegally used.

For this reason, in the conventional image processing method, the copyright of the former image can not be directly protected.

Therefore, the present invention has been made in consideration of such a drawback as above, and aims to provide an image processing apparatus, an image processing system and an image processing method which can surely protect the copyright and the like, a computer-readable storage medium which stores a program to execute the above image processing method, and the program itself.

### SUMMARY OF THE INVENTION

An object of the present invention is to provide an image processing apparatus which eliminated the above drawback, and a control method for the image processing apparatus.

Another object of the present invention is to provide an image processing apparatus which can surely protect a copyright of an image, and a control method for the image processing apparatus.

Other objects of the present invention will be apparent from the following explanation based on the attached drawings and the appended claims.

### BRIEF DESCRIPTION OF THE DRAWINGS

FIG. 1 is a block diagram showing the structure of an image input apparatus to which the first embodiment of the present invention is applied;

FIG. 2 is a diagram for explaining an electronic watermark processing information table included in the image input apparatus;

FIG. 3 is a flow chart for explaining the operation of the image input apparatus;

FIG. 4 is a block diagram showing the structure of an image input apparatus to which the second embodiment of the present invention is applied; and

FIG. 5 is a flow chart for explaining the operation of the image input apparatus.

### DETAILED DESCRIPTION OF THE PREFERRED EMBODIMENTS

Hereinafter, the preferred embodiments of the present invention will now be explained in accordance with the attached drawings.

(First Embodiment)

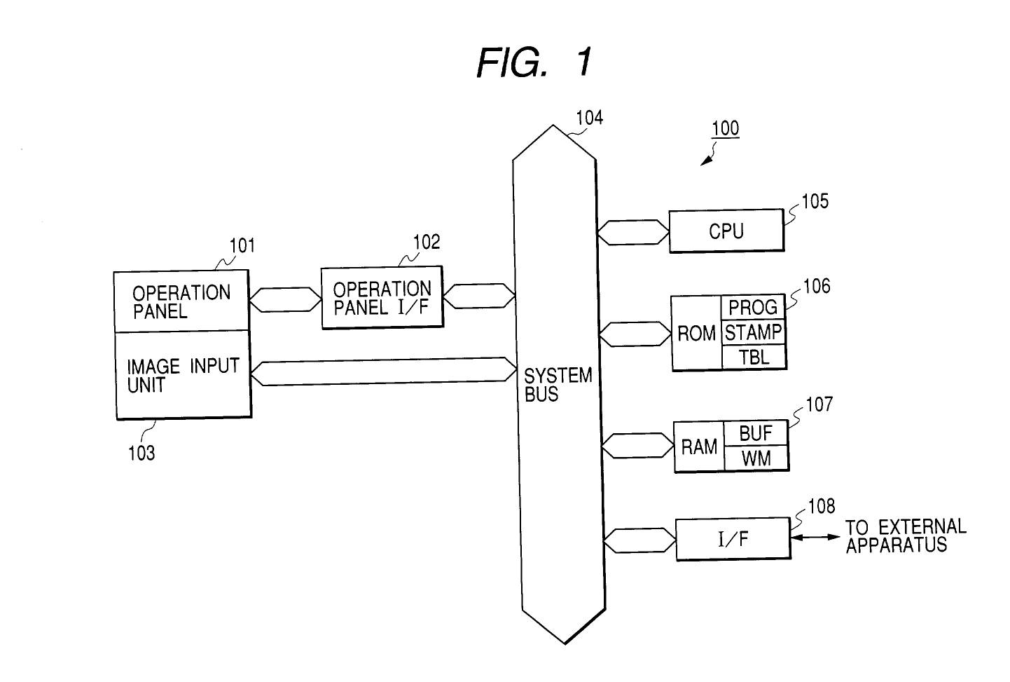

The present invention is applied to, e.g., an image input apparatus 100 as shown in FIG. 1.

The image input apparatus 100 according to the present embodiment includes various devices such as a scanner, a copier and the like, particularly, has an electronic watermark information detection function. Thus, if the image input apparatus 100 detects electronic watermark information from an image (read image) obtained by scanning a printed paper and the like, this apparatus performs an image process such as a deterioration process or the like to the read image on the basis of the detected electronic watermark information, and then outputs the processed image to a personal computer, a printer and the like, whereby it is possible to protect an author's copyright of the image.

Hereinafter, the structure and the operation of the image input apparatus 100 according to the present embodiment will be concretely explained.

<Structure of Image Input Apparatus 100>

In the image input apparatus 100, as shown in FIG. 1, an operation panel I/F (interface) 102 of an operation panel 101, an image input unit 103, a CPU 105, a ROM 106, a RAM 107, and an I/F 108 for interfacing with an external apparatus are mutually connected through a system bus 104 to be able to exchange various data among these devices.

A user can instruct, on the operation panel 101, the image input apparatus 100 to perform various operations. Then, the CPU 105 appropriately refers to operation information input by the user from the operation panel 101, through the operation panel I/F 102.

Although, in the present embodiment, the image input instruction and the like are issued from the operation panel 101 by way of example, the present invention is not limited to this. For example, the image input instruction and the like may be externally captured through the I/F 108.

The system bus 104 is the bus which mutually connects the various structural components (devices) of the image input apparatus 100.

The CPU 105 controls the operation of the image input apparatus 100 as a whole. Concretely, the CPU 105 reads and executes a predetermined program (PROG) stored in the ROM 106 to perform all processes including an obtaining process to obtain the operation information from the operation panel 101, a control process to capture the image input by the image input unit 103, a detection process to detect the electronic watermark information, a writing process to write the data input from the I/F 108, and the like.

The ROM 106 is the storage medium which stores various information used in the image input apparatus 100. Concretely, the ROM 106 includes an area PROG storing a processing program (i.e., a program indicating a processing procedure of the CPU 105) executed by the CPU 105, an area STAMP storing a later-described stamp image, and an area TBL storing a later-described electronic watermark processing information table.

The RAM 107 is the storage medium which holds various information necessary to operate the image input apparatus 100. Concretely, the RAM 107 includes a buffer area BUF holding a part or all of the images captured by the image input unit 107, and an area WM storing the detected electronic watermark information. In the present embodiment, it is assumed that the area WM has the size of, e.g., at least a two-bit width.

The I/F 108 is the interface for the external apparatus. For example, the I/F 108 is connected with a host computer such as the personal computer or the like, a network such as the Internet or the like, the apparatus such as the printer or the like, or the system. By the I/F 108, for example, the image data stored in the area BUF of the RAM 107 is transmitted externally.

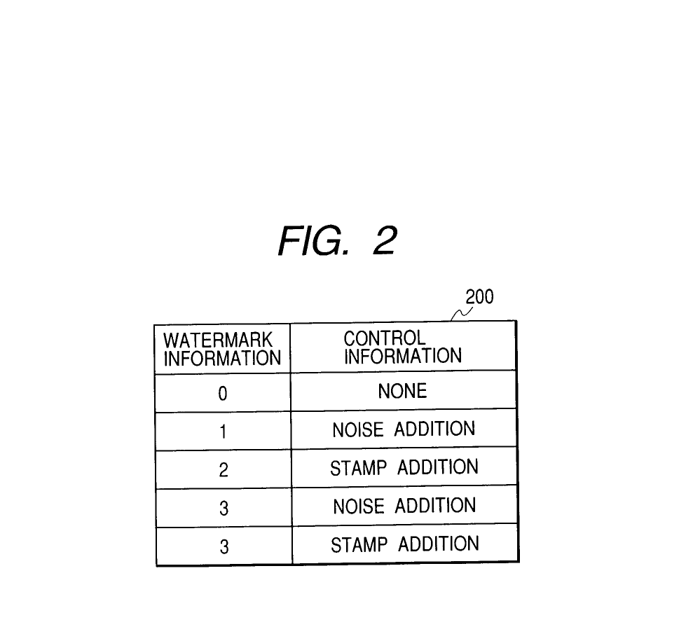

FIG. 2 shows an example of an electronic watermark processing information table 200 stored in the area TBL of the ROM 106.

The electronic watermark processing information table 200 includes thereon watermark information (or electronic watermark information) and control information.

The watermark information is two-bit information corresponding to the size (two bits) of the area WM of the RAM 107 storing the detected electronic watermark information, in the case where the electronic watermark information has been added to the image (former image) obtained by the image input unit 103. Here, any one of values “0” to “3” is set as the watermark information, that is, the electronic watermark information in the present embodiment includes the information representing any one of the values “0” to “3”.

As the control information, the information representing the control process corresponding to any one of the values “0” to “3” represented by the watermark information is set.

For example, if the watermark information is “0”, it represents “none (i.e., any control process is not performed)”. If the watermark information is “1”, it represents “noise addition (i.e., a process to add an arbitrary noise to the former image is performed)”. If the watermark information is “2”, it represents “stamp addition (i.e., a process to add an arbitrary stamp image to the former image is performed)”. Moreover, if the watermark information is “3”, it represents that both the processes “noise addition” and “stamp addition” are performed.

<Operation of Image Input Apparatus 100>

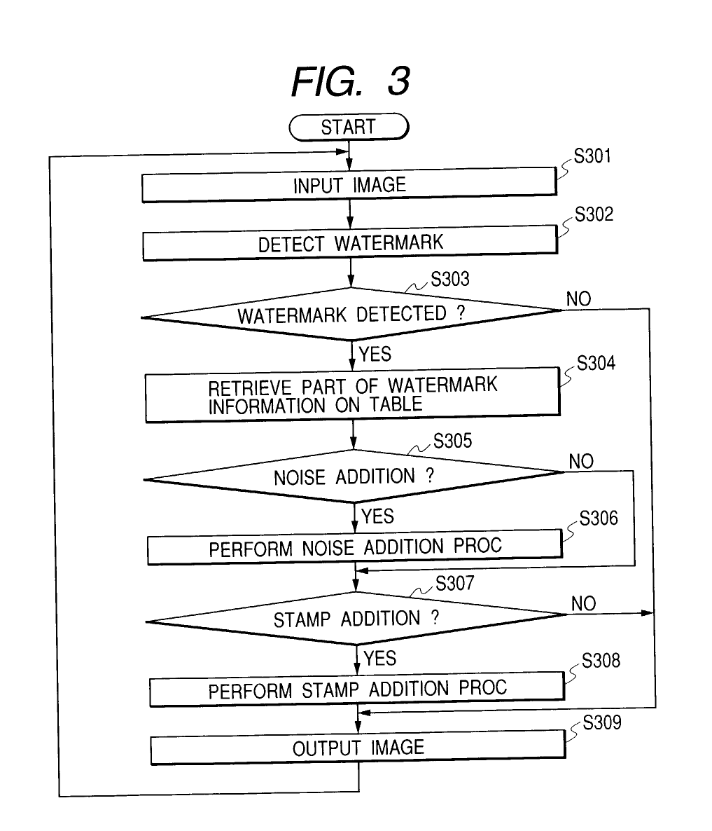

FIG. 3 shows the operation of the image input apparatus 100 as a flow chart.

For example, a processing program according to the flow chart shown in FIG. 3 is stored in the area PROG of the ROM 106. The CPU 105 reads the processing program from the area PROG of the ROM 106 and executes the read program, whereby the image input apparatus (image processing apparatus) 100 operates as follows.

Step S301:

The user performs an image input operation on the operation panel 101, and the operation information thus generated is supplied to the CPU 105 through the operation panel I/F 102.

Then, if the CPU 105 receives the operation information (i.e., an image reading instruction) from the operation panel I/F 102, it instructs the image input unit 103 to capture an image (former image) printed on paper.

The image input unit 103 obtains the former image by scanning it, and then outputs the obtained image to the buffer BUF of the RAM 107.

Step S302:

The CPU 105 tries to detect the electronic watermark from the image data (former image) in the buffer BUF of the RAM 107.

Step S303:

It is discriminated by the CPU 105 whether or not the electronic watermark information can be detected from the former image. If discriminated that the electronic watermark information can be detected, the flow advances to a next step S304, while if discriminated that the electronic watermark information can not be detected, the flow advances to a later-described step S309.

Step S304:

If discriminated in the step S303 that the electronic watermark information can be detected from the former image, the detected electronic watermark information is stored in the area WM of the RAM 107 by the CPU 105. Then, in order to determine the process to the image data (former image) in the buffer BUF of the RAM 107, the information corresponding to a part of the electronic watermark information (it is assumed that in the present embodiment this part corresponds to higher two bits of the electronic watermark information) stored in the area WM of the RAM 107 is retrieved, by the CPU 105, in the watermark information included in the electronic watermark processing information table 200 (FIG. 2) stored in the area TBL of the ROM 106. Thus, the control information corresponding to the value of the retrieved watermark information is obtained.

Step S305:

It is discriminated by the CPU 105 whether or not the control information obtained in the step S304 represents the noise addition process. If discriminated that the control information represents the noise addition process, the flow advances to a next step S306, while if discriminated that the control information does not represent the noise addition process, the flow directly advances to a later-described step S307.

Step S306:

If discriminated in the step S305 that the control information represents the noise addition process, the process to add the arbitrary noise to the image data (former image) in the buffer BUF of the RAM 107 is performed and then the processed image data is again stored in the buffer BUF by the CPU 105. This is to substitute the image data to which the process has been performed, for the image data to which the process is not yet performed.

Here, it should be noted that arbitrary means can be applied as the means for generating the arbitrary noise and the means for adding the generated noise to the image.

Step S307:

After the process in the step S306, or if discriminated in the step S305 that the control information does not represent the noise addition process, it is further discriminated by the CPU 105 whether or not the control information represents the stamp addition process. Then, if discriminated that the control information represents the stamp addition process, the flow advances to a next step S308, while if discriminated that the control information does not represent the stamp addition process, the flow directly advances to the later-described step S309.

Step S308:

If discriminated in the step S307 that the control information represents the stamp addition process, the process to overlap the stamp image stored in the area STAMP of the ROM 106 to the image data (former image) in the buffer BUF of the RAM 107 is performed and then the processed image data is again stored in the buffer BUF by the CPU 105.

Here, it should be noted that arbitrary means can be applied as the means for adding the stamp image to the former image.

Step S309:

After the process in the step S308, or if discriminated in the step S307 that the control information does not represent the stamp addition process, or if discriminated in the step S303 that the electronic watermark information can not be detected from the former image, the image data (i.e., the former image, the former image to which the noise has been added, or the former image to which the stamp image has been added) in the buffer BUF of the RAM 107 is output by the CPU 105 to the external apparatus (host computer, printer or the like) through the I/F 108.

After then, the flow again returns to the step S301 to repeat the above processes.

(Second Embodiment)

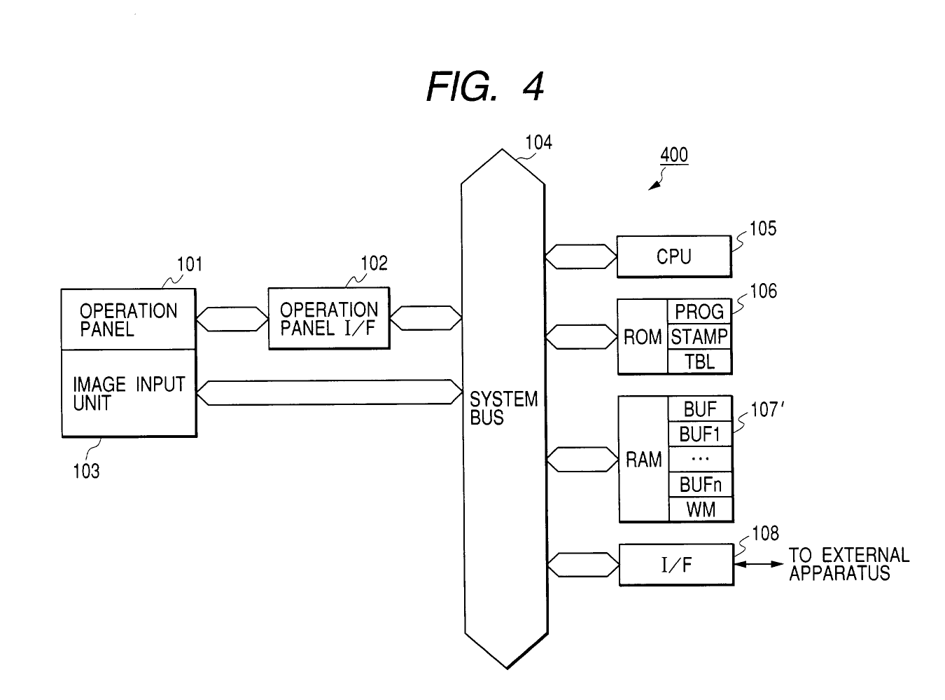

The present invention is applied to, e.g., an image input apparatus 400 as shown in FIG. 4.

In the present embodiment, a former image is first divided into plural cluster images, and then electronic watermark information is added to each of the cluster images, whereby the former image to which the electronic watermark information has been added is obtained as a whole. For this reason, in the image input apparatus 400 of the present embodiment, after the former image obtained by an image input unit 103 is divided into the plural cluster images, such a deterioration process to add a noise or a stamp image as in the first embodiment is performed to each of the cluster images.

Here, it should be noted that, in the image input apparatus 400 of FIG. 4, the parts functioning like the parts in the image input apparatus 100 of FIG. 1 are provided respectively by adding the same numerals as those in FIG. 1, and the detailed explanation thereof will be omitted.

<Structure of Image Input Apparatus 400>

The image input apparatus 400 is different from the image input apparatus 100 shown in FIG. 1 only in point of a RAM 107′ of FIG. 4.

That is, as shown in FIG. 4, the RAM 107′ of the image input apparatus 400 includes n buffer areas (also called buffers) BUF1 to BUFn. It should be noted that the n buffers respectively store n cluster images divided from the former image.

<Operation of Image Input Apparatus 400>

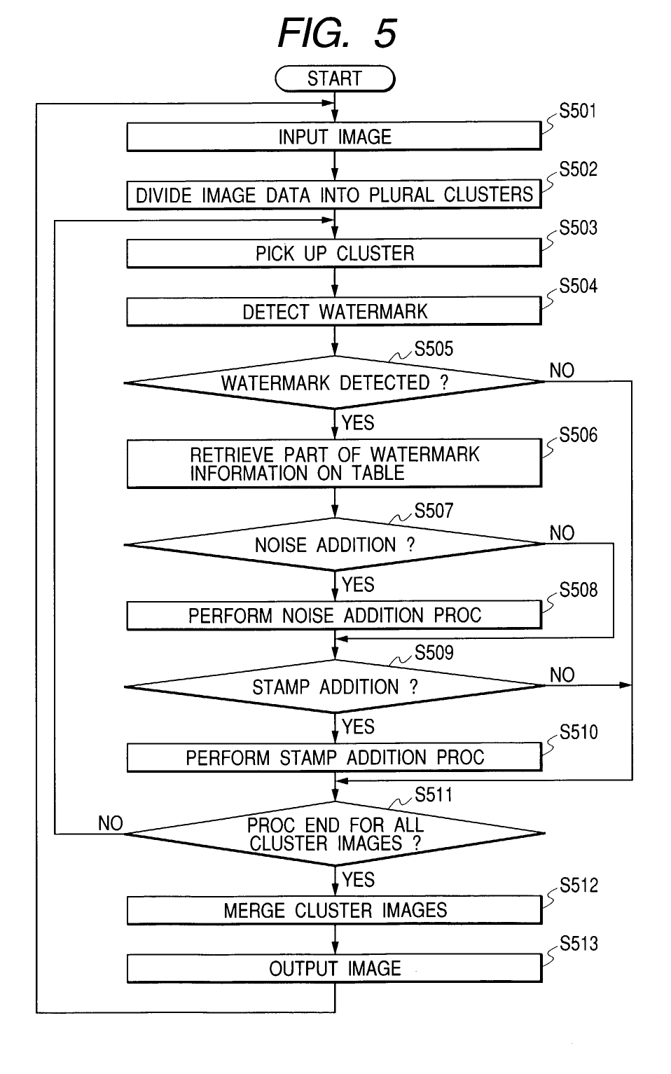

FIG. 5 shows the operation of the image input apparatus 400 as a flow chart.

For example, a processing program according to the flow chart shown in FIG. 5 is stored in an area PROG of a ROM 106. A CPU 105 reads the processing program from the area PROG of the ROM 106 and executes the read program, whereby the image input (processing) apparatus 400 operates as follows.

Step S501:

A user first performs an image input operation on an operation panel 101, and the operation information thus generated is supplied to the CPU 105 through an operation panel I/F 102.

Then, if the CPU 105 receives the operation information (i.e., an image reading instruction) from the operation panel I/F 102, it instructs the image input unit 103 to capture an image (former image) printed on paper.

The image input unit 103 obtains the former image by scanning it, and then outputs the obtained image to a buffer BUF of the RAM 107′.

Step S502:

The image data (former image) in the buffer BUF of the RAM 107′ is divided by the CPU 105 into the plural (upper limit is n) cluster images, and the divided cluster images are stored respectively in the buffers BUF1 to BUFn of the RAM 107′.

Here, for example, K-means algorithm is applicable as the method of dividing the former image, but the present invention is not limited to this, that is, an arbitrary method is applicable.

Step S503:

Then, the buffers BUF1 to BUFn of the RAM 107′ are one by one selected by the CPU 105. Here, it should be noted that the selected buffer is represented as a buffer BUFx.

Step S504:

The CPU 105 tries to detect the electronic watermark from the cluster image stored in the buffer BUFx of the RAM 107′.

Step S505:

It is discriminated by the CPU 105 whether or not the electronic watermark information can be detected from the cluster image. If discriminated that the electronic watermark information can be detected, the flow advances to a next step S506, while if discriminated that the electronic watermark information can not be detected, the flow advances to a later-described step S511.

Step S506:

If discriminated in the step S505 that the electronic watermark information can be detected from the cluster image, the detected electronic watermark information is stored in an area WM of the RAM 107′ by the CPU 105.

Then, in order to determine the process to the cluster image in the buffer BUFx of the RAM 107′, the value of the watermark information in the electronic watermark processing information table (FIG. 2) stored in the area TBL of the ROM 106 is compared with the information corresponding to a part of the electronic watermark information (it is assumed that in the present embodiment this part corresponds to higher two bits of the electronic watermark information) stored in the area WM of the RAM 107′, by the CPU 105. Thus, the control information corresponding to the value of the coincided watermark information is obtained.

Step S507:

It is discriminated by the CPU 105 whether or not the control information obtained in the step S506 represents a noise addition process. Then, if discriminated that the control information represents the noise addition process, the flow advances to a next step S508, while if discriminated that the control information does not represent the noise addition process, the flow directly advances to a later-described step S509.

Step S508:

If discriminated in the step S507 that the control information represents the noise addition process, the process to add an arbitrary noise to the cluster image in the buffer BUFx of the RAM 107′ is performed and then the processed image data is again stored in the buffer BUFx by the CPU 105.

Here, it should be noted that arbitrary means can be applied as the means for generating the arbitrary noise and the means for adding the generated noise to the cluster image.

Step S509:

After the process in the step S508, or if discriminated in the step S507 that the control information does not represent the noise addition process, it is further discriminated by the CPU 105 whether or not the control information represents a stamp addition process. Then, if discriminated that the control information represents the stamp addition process, the flow advances to a next step S510, while if discriminated that the control information does not represent the stamp addition process, the flow directly advances to the later-described step S511.

Step S510:

If discriminated in the step S509 that the control information represents the stamp addition process, the process to overlap the stamp image stored in an area STAMP of the ROM 106 to the cluster image in the buffer BUFx of the RAM 107′ is performed and then the processed image data is again stored in the buffer BUFx by the CPU 105.

Here, it should be noted that arbitrary means can be applied as the means for adding the stamp image to the cluster image.

Step S511:

After the process in the step S510, or if discriminated in the step S509 that the control information does not represent the stamp addition process, or if discriminated in the step S505 that the electronic watermark information can not be detected from the cluster image, it is further discriminated by the CPU 105 whether or not the processes in and after the step S503 end for all the cluster images. If discriminated that the processes do not end, the flow returns to the step S503 to repeat the above processes. On the other hand, if discriminated in the step S511 that the processes end for all the cluster images, the flow advances to a next step S512.

Step S512:

If discriminated in the step S511 that the processes end for all the cluster images, the cluster images stored in the buffers BUF1 to BUFx of the RAM 107′ are merged with others to generate the former image, and then the generated image is stored in the buffer BUF.

Step S513:

The image data (i.e., the former image, the cluster images to which the noises have been added, or the cluster images to which the stamp images have been added) in the buffer BUF of the RAM 107′ is output by the CPU 105 to the external apparatus (host computer, printer or the like) through the I/F 108.

After then, the flow again returns to the step S501 to repeat the above processes.

In the first and second embodiments, each of the image input apparatuses 100 and 400 detects and extracts the electronic watermark information from the former image, and then determines and performs the process on the basis of the extracted watermark information by referring to the electronic watermark processing information table 200 stored in the area TBL of the local ROM 106. However, for example, it is possible to structure the image input apparatus 100 or 400 so that a part or all of the electronic watermark information obtained from the former image is transmitted to a host computer or a server connected to the I/F 108, the process based on the electronic watermark information transmitted from the image input apparatus 100 or 400 is determined by the host computer or the server, and a notification of such determination and information necessary to perform the determined process are then transmitted to the image input apparatus 100 or 400 through the I/F 108.

It is needless to say that the object of the present invention can be achieved in a case where a storage medium storing the program codes of software to realize the functions of the first and second embodiments is supplied to a system or an apparatus and then a computer (or CPU or MPU) in the system or the apparatus reads and executes the program codes stored in the storage medium.

In this case, the program codes themselves read from the storage medium realize the functions of the first and second embodiments, whereby the storage medium storing these program codes constitutes the present invention.

As the storage medium for supplying the program codes, for example, a ROM, a flexible disk, a hard disk, an optical disk, a magnetooptical disk, a CDROM, a CD-R, a magnetic tape, a nonvolatile memory card, or the like can be used.

Moreover, it is needless to say that the present invention also includes not only a case where the functions of the first and second embodiments are realized by executing the program codes read by the computer, but also a case where an OS (operating system) or the like functioning on the computer executes a part or all of the actual process according to the instructions of the program codes, whereby the functions of the first and second embodiments are achieved by that process.

Moreover, it is needless to say that the present invention includes a case where the program codes read from the storage medium are once written in a memory provided in a function expansion board inserted in the computer or a function expansion unit connected to the computer, and then a CPU or the like provided in the function expansion board or the function expansion unit executes a part or all of the actual process according to the instructions of the program codes, whereby the functions of the first and second embodiments are achieved by that process.

As explained above, in the case where the electronic watermark information has been added to the input image input by scanning or the like of the recording medium such as the paper medium, the predetermined process (image deterioration process or the like) based on the electronic watermark information is performed to the input image, and the processed image is then output externally. Moreover, in the case where the input image is divided into the plural cluster images (divided images) and the electronic watermark information is added to each of the plural cluster images, the predetermined process based on the electronic watermark information is performed to the target cluster image, the processed cluster images are merged with others, and then the merged image is output externally.

By the above structure, for example, in the apparatus or the system which acts as the inlet for the image existing as the printed paper and having the copyright, it is possible to perform, to the image, the predetermined process based on the electronic watermark information added to this image, and thereafter output the processed image to the host computer on the user side. Thus, it is possible to prevent that, since the former image remains in the memory of the host computer on the user side, a large number of duplicates of the remaining image are improperly and illegally formed.

More particularly, for example, in the case where the printed paper on which the image having the electronic watermark information embedded by the author has been printed is scanned, the predetermined process intended by the author can be performed to the image obtained by the scan and then the processed image can be provided to the user side, whereby it is possible to protect the author's right.

Moreover, in the case where the author divides the image into the plural cluster images, embeds the inherent electronic watermark information in each of these images, and then prints the obtained image, the electronic watermark information can be detected from each cluster image and then the predetermined process can be performed to each cluster image on the basis of the electronic watermark information, whereby it is possible to more delicately protect the author's right.

What is claimed is:

1. An image processing apparatus comprising:
an input unit arranged to input an image;
a storage unit arranged to store the image input by said input unit;
a detection unit arranged to detect electronic watermark information from the input image;
a determination unit arranged to determine an image process to be performed to the input image, in correspondence with a kind of electronic watermark information detected by said detection unit;
a processing unit arranged to perform the image process determined by said determination unit, to the input image; and
an output unit arranged to substitute the image to which the image process was performed by said processing unit, for the image stored in said storage unit, and then output the substituted image externally.

2. An image processing apparatus according to claim 1, further comprising a table arranged to store kinds of image processes to be performed to the input image by said processing unit, in correspondence with the kinds of electronic watermark information.

3. An image processing apparatus according to claim 1, wherein the image process is the image process to prevent faithful output of the input image.

4. An image processing apparatus according to claim 3, wherein the image process includes a process to add a noise to the input image or a process to add a predetermined image to the input image.

5. An image processing apparatus comprising:
an input unit arranged to input an image;
a division unit arranged to divide the image input by said input unit into plural areas;
a storage unit arranged to store the images of the respective areas divided by said division unit;
a detection unit arranged to detect electronic watermark information from the image of each of the plural areas divided by said division unit;
a determination unit arranged to determine an image process to be performed to the input image for each area, in correspondence with the electronic watermark information detected by said detection unit;
a processing unit arranged to perform the image process determined by said determination unit, to the input image for each area; and
an output unit arranged to substitute the image for each area to which the image process was performed by said processing unit, for the image stored in said storage unit, merge the substituted images of the respective areas with others, and then output the merged image externally.

6. An image processing apparatus according to claim 5, further comprising a table arranged to store kinds of image processes to be performed to the input images by said processing unit, in correspondence with the kinds of electronic watermark information.

7. An image processing apparatus according to claim 5, wherein the image process is the image process to prevent faithful output of the input image.

8. An image processing apparatus according to claim 7, wherein the image process includes a process to add a noise to the input image or a process to add a predetermined image to the input image.

9. An image processing method comprising the steps of:
inputting an image;
storing the image input in said input step, in a memory;
detecting electronic watermark information from the input image;
determining an image process to be performed to the input image, in correspondence with a kind of electronic watermark information detected in said detection step;
performing the image process determined in said determination step, to the input image; and
substituting the image to which the image process was performed in said performing step, for the image stored in the memory, and then outputting the substituted image externally.

10. An image processing method according to claim 9, wherein, in said determination step, the image process to be performed to the input image in said performing step is determined by referring to a table arranged to store kinds of image processes in correspondence with the kinds of electronic watermark information.

11. An image processing method according to claim 9, wherein the image process is the image process to prevent faithful output of the input image.

12. An image processing method according to claim 11, wherein the image process includes a process to add a noise to the input image or a process to add a predetermined image to the input image.

13. An image processing method comprising the steps of:
inputting an image;
dividing the image input in said input step into plural areas;
storing the images of the respective areas divided in said division step, in a memory;
detecting electronic watermark information from the image of each of the plural areas divided in said division step;
determining an image process to be performed to the input image for each area, in correspondence with a kind of electronic watermark information detected in said detection step;
performing the image process determined in said determination step, to the input image for each area; and
substituting the image for each area to which the image process was performed in said performing step, for the image stored in the memory, merging the substituted images of the respective areas with others, and then outputting the merged image externally.

14. An image processing method according to claim 13, wherein, in said determination step, the image process to be performed to the input image in said performing step is determined by referring to a table arranged to store kinds of image processes in correspondence with the kinds of electronic watermark information.

15. An image processing method according to claim 13, wherein the image process is the image process to prevent faithful output of the input image.

16. An image processing method according to claim 15, wherein the image process includes a process to add a noise to the input image or a process to add a predetermined image to the input image.

17. A computer-readable storage medium which stores a program to execute an image processing method, said method comprising the steps of:
inputting an image;
storing the image input in said input step, in a memory;
detecting electronic watermark information from the input image;
determining an image process to be performed to the input image, in correspondence with a kind of electronic watermark information detected in said detection step;
performing the image process determined in said determination step, to the input image; and
substituting the image to which the image process was performed in said performing step, for the image stored in the memory, and then outputting the substituted image externally.

18. A computer-readable storage medium which stores a program to execute an image processing method, said method comprising the steps of:
inputting an image;
dividing the image input in said input step into plural areas;
storing the images of the respective areas divided in said division step, in a memory;
detecting electronic watermark information from the image of each of the plural areas divided in said division step;
determining an image process to be performed to the input image for each area, in correspondence with a kind of electronic watermark information detected in said detection step;
performing the image process determined in said determination step, to the input image for each area; and
substituting the image for each area to which the image process was performed in said performing step, for the image stored in the memory, merging the substituted images of the respective areas with others, and then outputting the merged image externally.
